(19) United States
(12) Patent Application Publication
(10) Pub. No.: US 2018/0359552 A1
(43) Pub. Date: Dec. 13, 2018

(54) Wireless Earpieces with a Memory Coach

(71) Applicant: BRAGI GmbH, Munchen (DE)

(72) Inventor: Peter Vincent Boesen, Munchen (DE)

(73) Assignee: BRAGI GmbH, Munchen (DE)

(21) Appl. No.: 16/000,738

(22) Filed: Jun. 5, 2018

Related U.S. Application Data
(60) Provisional application No. 62/516,845, filed on Jun. 8, 2017.

(51) Int. Cl. H04R 1/10; G06F 17/30

(52) U.S. Cl. CPC H04R 1/1016; H04R 2420/07; G06F 17/3074

(57) ABSTRACT

A wireless earpiece includes an earpiece housing, a processor disposed within the earpiece housing, a microphone operatively connected to the processor, a speaker operatively connected to the processor, one or more sensors operatively connected to the processor, a memory operatively connected to the processor, and a memory application stored in the memory and executable by the processor, wherein the memory application is configured to generate a memory application test for the user to test a memory of the user wearing the wireless earpiece. The memory application test may include a plurality of audio questions transduced at the speaker with responses to the plurality of audio questions received by at least one of the microphone and the one or more sensors. The memory application test may provide for evaluating the responses to the plurality of audio questions to generate a memory application test score.

### PRIORITY STATEMENT

This application claims priority to U.S. Provisional Patent Application No. 62/516,845 filed on Jun. 8, 2017 titled Wireless Earpieces with a Memory Coach, which is hereby incorporated by reference in its entirety.

### FIELD OF THE INVENTION

The illustrative embodiments relate to wearable devices. Particularly, the illustrative embodiments relate to wireless earpieces. More particularly, but not exclusively, the illustrative embodiments relate to memory training utilizing wireless earpieces.

### BACKGROUND

Wireless earpieces are a new category of consumer electronics. Wireless earpieces allow the user to listen to songs, news, or other types of media without the need to be directly connected to another electronic device. Applications testing or coaching the memories of earpiece users, however, have not been explored. What is thus needed are systems and methods of testing the memories of users while wearing an earpiece.

### SUMMARY

Therefore, it is a primary object, feature, or advantage to improve over the state of the art.

It is an object, feature, or advantage to provide a memory test using an earpiece.

It is a still further object, feature, or advantage to provide a memory coaching application using the wireless earpiece.

Another object, feature, or advantage is to record body movements using one or more sensors of the wireless earpiece.

Yet another object, feature, or advantage is to provide feedback to the user performing a memory test.

Yet another object, feature, or advantage is to aid the user performing the memory test.

Yet another object, feature, or advantage is to provide audio feedback to the user using a memory coaching application.

Yet another object, feature, or advantage is to provide audio feedback to the user using a memory coaching application using three-dimensional audio cues.

Yet another object, feature, or advantage is to provide hints to the user when performing a memory application.

Yet another object, feature, or advantage is to communicate the audio feedback using a bone conduction microphone.

Yet another object, feature, or advantage is to communicate sensor readings between a set of earpieces.

According to one aspect of the present invention the wireless earpieces can collect context-driven data which may be used to assist the memory coach, data which can be used to assist in determining how best to coach the user. The context-driven data comes from onboard sensors and/or any other inputs which can provide insight into how the user is behaving, emotions rendered, and movements performed.

According to another aspect, an earpiece includes an earpiece housing, a processor disposed within the earpiece housing, a microphone operatively connected to the processor, a speaker operatively connected to the processor, a sensor operatively connected to the processor, a memory operatively connected to the processor, and a memory application stored on the memory and executable by the processor, wherein the memory application comprises a set of instructions for testing a memory of the user wearing the wireless earpiece. One or more of the following features may be included. The memory application may be a short-term memory test or a long-term memory test. The memory application may be a memory coaching application. The memory application may be a program comprising a memory coaching application. The memory application may be activated in response to a voice command from the user received by the microphone. The sensor may further comprise a MEMS gyroscope and an electronic accelerometer. The sensor may be configured to sense body movements of the user. The body movements sensed by the sensor may be stored on the memory. The set of instructions may further comprise providing verbal feedback to the user in response to an action not in accordance with the memory coaching application. The set of instructions may further comprise providing three-dimensional sound cues via the speaker using the body movements sensed by the sensor.

According to another aspect, a method of providing a memory application using an earpiece includes receiving an input from a user at the wireless earpiece and administering the memory application to the user in response to the input. One or more of the following features may be included. The wireless earpiece may be worn in the ear of the user. The input may be a voice command. The input may be a sensor reading. The memory application may be a memory test or a memory coaching application. The sensor readings may be stored on a memory. Audio feedback may be communicated to the user if the user does not correctly adhere to the memory application. The audio feedback may be provided using three-dimensional audio cues.

The illustrative embodiments provide wireless earpieces including components and functionality for performing memory testing or memory maintenance. The memory testing and/or maintenance may be performed in various ways. For example, the wireless earpieces may administer memory testing in various ways and record or maintain the results of such testing. In one embodiment, the wireless earpieces may provide for improving the ability to remember by periodically asking questions which may promote and improve memory. In another embodiment, the wireless earpieces may determine questions to ask as a part of memory/awareness testing based on data received using onboard sensors or from connected devices.

A wireless earpiece in embodiments of the present invention may have one or more of the following features: (a) an earpiece housing, (b) a processor disposed within the earpiece housing, (c) a microphone operatively connected to the processor, (d) a speaker operatively connected to the processor, (e) one or more sensors operatively connected to the processor, (f) a memory operatively connected to the processor, (g) a memory application stored in the memory and executable by the processor, wherein the memory application can test a memory of the user wearing the wireless earpiece, and (h) context-driven data, provided by the one or more sensors, providing results of the memory application test.

A method of providing a memory application using an earpiece in embodiments of the present invention may have one or more of the following steps: (a) receiving an input from a user at the wireless earpiece, (b) executing a memory application for the user in response to the input, (c) prompting the user to remember information, (d) requesting the information from the user, (e) receiving user input in response to requesting the information from the user, and (f) communicating audio feedback to the user if the user does not correctly adhere to the memory application.

A method for testing a memory of a user utilizing wireless earpieces in embodiments of the present invention may have one or more of the following steps: (a) testing the memory of the user to determine a baseline level, (b) performing memory exercises based on the baseline level determined for the user, (c) receiving user input based on the memory exercises, (d) scoring the user based on the memory exercises, (e) determining mental health of the user based on the score and the memory exercises and testing, and (f) communicating the scoring and results of the memory exercises to one or more designated parties.

According to another aspect, a wireless earpiece includes an earpiece housing, a processor disposed within the earpiece housing, a microphone operatively connected to the processor, a speaker operatively connected to the processor, one or more sensors operatively connected to the processor, a memory operatively connected to the processor, and a memory application stored in the memory and executable by the processor, wherein the memory application is configured to generate a memory application test for the user to test a memory of the user wearing the wireless earpiece. The memory application test may include a plurality of audio questions transduced at the speaker with responses to the plurality of audio questions received by at least one of the microphone and the one or more sensors. The memory application test may provide for evaluating the responses to the plurality of audio questions to generate a memory application test score. The memory application may use context-driven data, provided by the one or more sensors in evaluating the responses. The memory application is a memory coaching application.

According to another aspect, a method of providing a memory application using an earpiece includes receiving an input from a user at the wireless earpiece, executing a memory application by a processor of the earpiece for the user in response to the input, prompting the user to remember information, the prompting performed by the earpiece, requesting the information from the user, the requesting performed by the earpiece, and receiving user input at the earpiece in response to requesting the information from the user.

According to another aspect, a method for testing a memory of a user utilizing wireless earpieces includes testing the memory of the user by the wireless earpieces to determine a baseline level, performing memory exercises based on the baseline level determined for the user, receiving at the wireless earpieces user input based on the memory exercises, and scoring the user based on the memory exercises, the scoring performed by the wireless earpieces.

One or more of these and/or other objects, features, or advantages of the illustrative embodiments will become apparent from the specification and claims following. No single embodiment need provide every object, feature, or advantage. Different embodiments may have different objects, features, or advantages. Therefore, the illustrative embodiments are not to be limited to or by any object, feature, or advantage stated herein.

### BRIEF DESCRIPTION OF THE DRAWINGS

Illustrated embodiments of the disclosure are described in detail below with reference to the attached drawing figures, which are incorporated by reference herein.

FIG. 1 illustrates a block diagram of the wireless earpiece in accordance with an illustrative embodiment of the present invention;

FIG. 2 illustrates a second embodiment of the wireless earpiece in accordance with an illustrative embodiment of the present invention;

FIG. 3 illustrates a set of wireless earpieces in accordance with an illustrative embodiment of the present invention;

FIG. 4 illustrates a right wireless earpiece and the associated relationship with a user's ear in accordance with an illustrative embodiment of the present invention;

FIG. 5 illustrates a set of wireless earpieces and their relationship with a mobile device in accordance with an illustrative embodiment of the present invention;

FIG. 6 illustrates a flowchart of a method of providing a memory application using a wireless earpiece in accordance with an illustrative embodiment of the present invention;

FIG. 7 illustrates a flowchart of a method of providing a memory test to a user wearing a wireless earpiece in accordance with an illustrative embodiment of the present invention;

FIG. 8 illustrates a flowchart of a method of providing a memory coaching application with an earpiece having at least one sensor in accordance with an illustrative embodiment of the present invention; and

It is to be understood the illustrative embodiments contemplate all permutations and combinations of the various graphical elements and associated description set forth in the Figures and any portions thereof.

### DETAILED DESCRIPTION

The following discussion is presented to enable a person skilled in the art to make and use the present teachings. Various modifications to the illustrated embodiments will be clear to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of memory coaching utilizing wireless earpieces, it is fully contemplated embodiments of the present invention could be used in most any wearable electronic device without departing from the spirit of the invention.

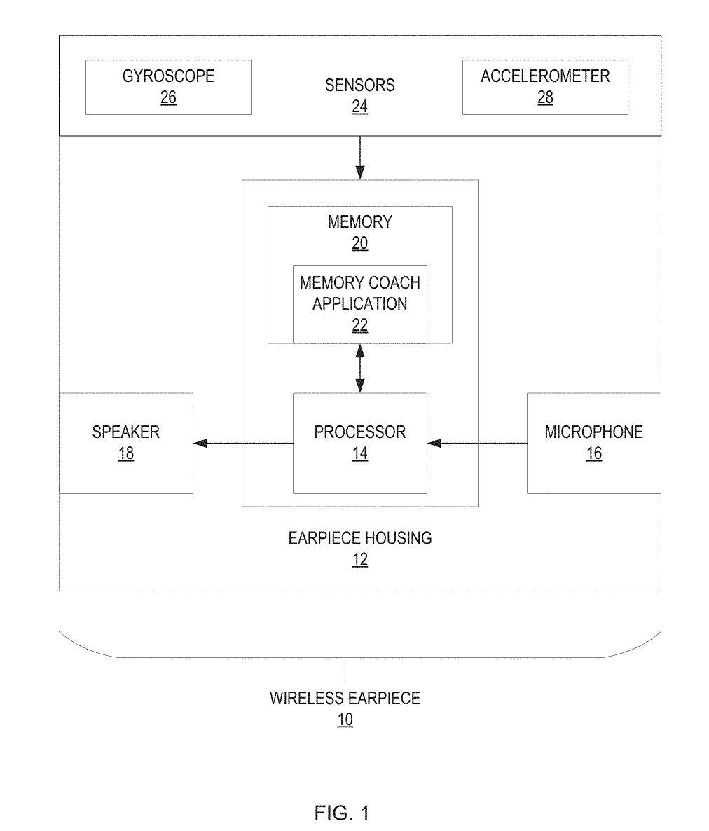

FIG. 1 illustrates a block diagram of a wireless earpiece 10. The wireless earpiece 10 includes an earpiece housing 12, a processor 14 disposed within the earpiece housing 12, a microphone 16, a speaker 18, sensors 24, and a memory 20 having a memory coach application 22 stored thereon having programming executable by the processor 14 for administering to a user of the wireless earpiece 10 to test the user's memory. The components of the wireless earpiece 10 may be operatively connected utilizing one or more busses, wires, traces, contacts, interfaces, or so forth. For example, the components may be controlled through a connection to the processor 14. One or more sleeves (not shown) may be provided with the wireless earpiece 10 fitted over a portion of the earpiece housing 12. The sleeves may come in various shapes and sizes and may be used to improve the fit of the wireless earpiece 10 within an ear of the user, improve audio transparency, improve the longevity of the wireless earpiece 10, protect the user from skin allergies, and so forth.

The earpiece housing 12 is a structure shaped to fit substantially within an ear of the user. The earpiece housing 12 may at least partially enclose one or more of the components of the wireless earpiece 10 and may be composed of plastic, metal, polymers, non-metals, or any material or combination of materials having substantial deformation resistance to facilitate energy transfer if a sudden force is applied to the wireless earpiece 10. For example, if the wireless earpiece 10 is dropped by the user, the earpiece housings 12 may transfer the energy received from the surface impact throughout the entire wireless earpiece 10, minimizing damage.

In addition, the earpiece housing 12 may be capable of a degree of flexibility to facilitate energy absorbance if one or more forces is applied to the wireless earpiece 10. For example, if an object is dropped on the wireless earpiece 10, the earpiece housing 12 may bend to absorb the energy from the impact. The flexibility of the earpiece housing 12 should not, however, be flexible to the point where one or more components of the wireless earpiece 10 may become dislodged or otherwise rendered non-functional due to the force of the impact. The earpiece housing 12 may also waterproof enclosed components within the wireless earpiece 10. The earpiece housing 12 may also enclose the connectors (e.g., wires, busses, connectors, contacts, etc.) interconnecting the various electrical components.

The processor 14 is disposed within, mounted to, or integrated with the earpiece housing 12 and is operatively connected to all or a portion of the components of the wireless earpiece 10. The processor 14 may include a digital signal processor, a mixed signal processor, a microcontroller and combinations thereof.

Furthermore, processor 14 may be programmed to execute one or more kernels, applications, programs, and/or instructions to control the wireless earpiece 10 or process information received from one or more of the components of the wireless earpiece 10. The kernels, applications, programs, and/or instructions used by the processor 14 may be stored in memory 20, or one or more cache memories within the processor 14. For example, the processor 14 may process a request from the user to access a short-term memory test stored on the memory 20 using a kernel to interpret a signal derived from the request received at microphone 16. The signal may encode data or information the kernel interprets as requesting, for example, a short-term memory test to test the user's ability to recall a string of numbers ten seconds after the string of numbers is communicated to the user via speaker 18. Instructions within the short-term memory test may be subsequently executed by the processor 14 to compare the user's response received by the microphone 16 with the number communicated to the user, which may be stored in the memory 20, to ascertain whether the user provided the correct answer.

The microphone 16 is operatively connected to the processor 14 and may be disposed within, mounted to, or integrated with the earpiece housing 12. Analog-to-digital converters, amplifiers, attenuators, filters, and/or other components necessary for the use of microphone 16 to convert a sound wave into an electrical signal may be provided as a part of the microphone, a part of the processor, or separately. The microphone 16 may be positioned on a section of the earpiece housing 12 facing away from the user's ear to receive a voice command or other audio input from the user, a third party, or the ambient environment. For example, the user may issue a verbal request to the wireless earpiece 10 to access a long-term memory test stored in the memory 20 via the microphone 16. In addition, voice commands and audio input received by the microphone 16 may be stored in the memory 20 for future use by one or more applications or other programs, including memory tests, stored in the memory 20.

The speaker 18 is operatively connected to the processor 14 and may be disposed within, mounted to, or integrated with the earpiece housing 12. The speaker 18 may be positioned in an area conducive for communicating sounds to the tympanic membrane of the user's ear. Digital-to-analog converters, amplifiers, attenuators, filters, and/or other components useful for the speaker 18 to convert an electrical signal into a sound wave may be integrated into the speaker, the processor, or separately provided. Communications from the speaker 18 may include one or more memory tests, information related to one or more memory tests, information related to the wireless earpiece 10, or other information requested, useful, important, or necessary to the user. The processor 14 may be further configured and/or programmed to generate three-dimensional stereo sound or to generate sounds at specific frequencies. For example, if the user is performing a memory test related to location, the speaker 18 may produce three-dimensional sound cues if allowed by the memory test or desired by the user. The sounds may be louder and/or more frequent the closer the user is to the correct location.

The memory 20 is operatively connected to the processor 14 and may be disposed within, mounted to, or integrated with the earpiece housing 12. The memory 20 may store at least one memory coach application 22. The memory 20 may be any type of non-volatile memory, including static and/or dynamic memory, allowing data storage when the wireless earpiece 10 is not powered. In some embodiments, additional volatile memories, such as random-access memories, may be incorporated into the memory 20 to allow for improved functionality. The memory 20 may be configured and/or programmed to store kernels, applications, programs, instructions and/or data for either concurrent or future use and in some embodiments the memory 20 may be integrated with the processor 14 for improved functionality. The memory 20 may also store responses provided by the user during a memory test, sounds and/or audio concerning one or more third parties, ambient sounds, or information received from third party electronic devices. In addition, memory 20 may store applications or programs related to optional components of the wireless earpiece 10. The memory 20 may also store biometric readings from the sensors 24. Further, the memory can also store context-driven data (e.g., data provided by sensors 24 providing information about the user, such as body movement, heart rate and facial expressions) which may be used to assist with the memory coach program. The context-driven data can be used to assist in determining how best to coach the user. The context-driven data may be information about the user or the about the user's environment including location, activity, or other information which may be used in generating test queries and/or in evaluating test responses of the user.

One or more memory applications 22, programs, operating systems, kernels, software modules, or sets of instructions are stored within the memory 20. For example, each memory coach application 22 may be executed by the processor 14 in response to a request or a command from the user, a third party, or in response to one or more ambient sounds. The memory coach application 22 may be a memory test or a memory coaching application. The types of memory tests stored in the memory 20 include one or more short-term memory tests, one or more long-term memory tests, one or more rehabilitation tests, one or more physical training tests, or any other type of test in which a user's memory is involved. For example, short-term memory tests may include, but are not limited to, 1) number tests, in which a number of a certain length is communicated via the speaker 18 to the user who must successfully repeat the number back to the wireless earpiece 10 via the microphone 16, 2) sentence or word tests, where a sentence is communicated to the user via the speaker 18 who must successfully repeat each word in a sentence in the correct order to the wireless earpiece 10 via the microphone 16, 3) word tests, where a sequence of words is provided and the user must correctly repeat the sequence to the wireless earpiece 10, 4) sound tests, where a sequence of sounds is communicated via the speaker 18 and the user must verbally recreate what the user heard, or other types of short-term memory tests involving sound, 5) trivia tests, 6) audio description requiring answers, 7) physical performance tests where the user must execute proper form for a task (e.g., a proper golf swing) and/or other additional tests (as noted the aforementioned list is non-exclusive). In addition, one or more of the tests may be integrated together to create a more comprehensive short-term memory test.

Long-term memory tests may include, but are not limited to, (1 tests similar to short-term memory tests except the user is prompted for the answer at a later time (e.g., after a time period greater than 30 seconds, which is longest estimated duration of short term memory), (2 tests involving what the user did during a specific time of the current day or what the user did during a specific time at an earlier date, (3 tests involving the location of the user when performing a specific action at a specific time, and/or (4 tests involving particular details of certain events related to the user (e.g., who the user was talking to or how the user accomplished a task, at particular times and/or places) actions taken by the user, or the environment of the user. Data and/or information for use in long-term memory tasks may be received directly by the user, indirectly by the user, from one or more third parties, or from the ambient environment and stored in the memory 20 for future use. For example, a long-term memory test program stored in the memory 20 may be executed by the processor 14 in response to a request from the user or a third party to test the user's ability to remember what the user did at certain times and/or at certain places during the week. Information related to what the user did may be received by prompting the user for what the user did at certain times and storing the user's responses in the memory in accordance with instructions within the long-term memory test program and/or by recording the ambient sounds at the microphone 16. In another embodiment, the information may be received from applications of the wireless earpiece 10 or a wireless device linked with the wireless earpiece 10, such as applications utilized (e.g., mapping location, purchases, entertainment choices, texts, messages, etc.). The user may utilize user preferences or settings to authorize the information utilized for the memory tests.

The information stored in the memory 20 does not necessarily have to be performed in accordance with the long-term memory test; the ambient sounds, for example, may be recorded automatically with a time stamp and be correlated with certain user actions by the long-term memory test program or another program or application when needed. In addition, the ambient sounds may be used to provide hints or context to questions communicated by the speaker 18. User input and responses may be provided by the user via the microphone 16 or sensors 24, such as touch screens, magnetometers, the gyroscope 26, the accelerometer, and so forth. These user input and responses can also provide memory coach application 22 with context-driven data, which memory coach application may use to evaluate the user's performance in memory coaching. Any number of voice commands, gestures, swipes, taps, head gestures, and so forth may be utilized to receive the user input, responses, answers, feedback and context. The long-term memory test program may subsequently store the answers provided by the user for further use and provide a score or evaluation as to the user's memory or mental capacity. The results may also be used by a doctor or other mental health professional in providing a diagnosis regarding the user's mental state, mental health, or other medical condition concerning the user's mental functions. The score may be saved for later reference by the user to show progress. The score may also be distributed for any number of relevant parties.

Memory coach applications or programs, such as the memory coach application 22, may also be stored on the memory 20 and may be used in various medical or physical applications. For example, the memory coach application 22 may be a cognitive program for testing user memory in relation to motor function and coordination requested by a user who is undergoing physical therapy or a third party, such as a medical professional, family member, guardian, or so forth. The memory coach application 22 may require the user to first perform one or more physical gestures or activities with the help of the program (for example to calibrate or to provide a baseline in which to measure performance) and then perform the same physical gestures or activities a second or subsequent time without the assistance of the memory coach application 22. Physical gestures, user orientation, movements, actions, or activities (e.g., providing context) may be sensed by one or more sensors 24 (e.g., optical, contact, radar, etc.) (e.g., contextual data) operatively connected to the wireless earpiece 10 and may be used by the cognitive program (e.g., contextual-driven data) and/or stored in the memory 20. A memory coach application 22, which may be part of the cognitive program or a separate application, may be used in conjunction with the cognitive program by the user to provide clues or audio cues as to which action to perform.

In addition, the memory coach application 22 may be used in association with a dance program to test the performance of the user in performing one or more dance routines. The memory coach application 22 may be part of the dance program or a separate application. The dance routines may include, but are not limited to, one or more head movements, one or more arm movements, one or more leg movements, one or more foot movements, one or more hip movements, one or more abdominal movements, one or more jumps, one or more somersaults, one or more handstands, and/or one or more other movements reasonably associated with a dance routine. The memory coach application 22 may provide feedback regarding how well the user performed the dance routine, provide three-dimensional audio cues via the speaker 18 as to what action to perform (e.g., if the user is having difficulty remembering the dance routine), provide verbal clues via the speaker 18 if the user is having difficulty remembering the dance routine or in response to a request by the user related to the dance routine, and/or provide continuous updates regarding the user's performance.

In another embodiment, the memory coach application 22 may be used in conjunction with a program testing muscle memory and position. For example, a user may access a yoga program stored on the memory 20 using a voice command received by the microphone 16 and may additionally access a memory coach application 22 if the yoga program lacks such a function. The yoga program may then instruct the user via the speaker 18 to move into a certain pose and the contextual data may be sensed by the sensors 24. Later, the same yoga program may instruct the user to move into the same pose, wherein the sensors 24 again sense the position of the user. The yoga program may then compare the present position with the past position to ensure the user is performing the exercises correctly or to ensure the user is improving. If the user does not have the correct positioning, the memory coaching application 22 may provide feedback or audio cues to help the user move into the proper position. The memory coaching application may also provide tips in remembering or adhering to the yoga routine.

In another embodiment, the memory coach application 22 may be utilized to train or test employees, students, soldiers, teachers, trainers, or other individuals. For example, the memory coach application 22 may ask the user questions requiring a user response. As noted, the user response may represent verbal communications, body orientation or position, actions, or so forth. The memory coach application 22 may be utilized to both train and test a user for specific actions, behaviors, activities, or so forth.

One or more sensors 24 is operatively connected to the processor 14 and may be mounted to or integrated with the earpiece housing 12. The sensors 24 may include a microelectromechanical systems (MEMS) gyroscope, a magnetometer, an accelerometer, an EMG sensor, touch/capacitive sensors, optical sensors (e.g., visible light, infrared, etc.), radar, LIDAR, and/or one or more other types of electronic sensors capable of sensing physical movements. For example, a gyroscope 26 (e.g., MEMs gyroscope, gyrostat, inertial measurement units—IMU, etc.) may sense the orientation of the user's head relative to an initial or default position when one or more physical activities is performed and an electronic accelerometer 28, which may be piezoelectric, piezo resistive, or capacitive, may sense one or more accelerations related to one or more physical activities, which may be the same physical activities used in measuring the orientation of the user's head. The readings from the gyroscope 26 and the accelerometer 28 may be communicated to the processor 14, which may use the readings when executing a memory test program or application and/or executing the memory coach application 22. In addition, the processor 14 may store the readings in the memory 20 for later use.

Sensor readings derived from the sensors 24 stored in the memory 20 may be used by the memory coach application 22 in relation to one or more physical activity programs. For example, if the user is using the memory coach application 22 along with a dance program, the readings from the sensors 24 may be compared with a dance routine template, (e.g., the dance routine template is an executable profile of a model sequence of gyroscope 26 and accelerometer 28 sensor readings corresponding to a specific dance routine). The memory coach application 22 may be part of the dance program or a separate application used by the dance program. If the sensor readings from the sensors 24 substantially match the dance routine template at the end of the dance program, the memory coach application 22 may instruct the speaker 18 to produce a communication telling the user they successfully completed the dance routine.

If at any point during the dance routine the user makes a mistake, the memory coach application 22 may perform any of the following: cease the dance routine, instruct the speaker 18 to provide three-dimensional audio cues in the area of the correct body movement when the user makes a mistake, go back to a certain point in the dance routine and instruct the speaker 18 to produce a communication notifying the user to try again, go back to a certain point in the dance program and subsequently recommence the dance program and instruct the speaker 18 to communicate three-dimensional audio cues in the general area of the body movements corresponding to the proper body movements of the dance routine, go back to a certain point in the dance program and subsequently recommence the dance program and instruct the speaker 18 to communicate verbal hints to help the user remember the proper steps of the dance routine, provide feedback via the speaker 18 regarding the user's performance using the sensor readings from the sensors 24, or one or more other actions to help the user properly complete the dance routine. Other types of programs, such as training programs, work optimization programs, study programs, rehabilitative programs, physical therapy programs, gait analysis programs, motor function programs, balance and coordination programs, or other similar programs or applications may also employ the memory coaching application or sub-application using sensor readings from the sensor 24.

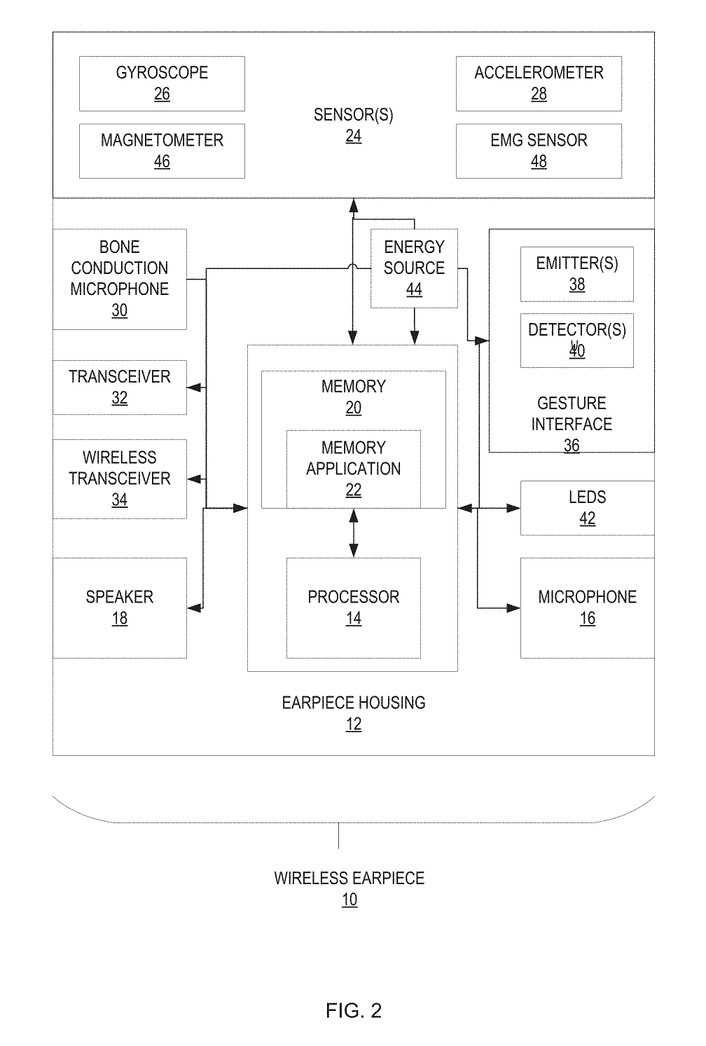

FIG. 2 illustrates another example of the wireless earpiece 10. In addition to an earpiece housing 12, a processor 14, a microphone 16, a speaker 18, a memory 20 with a memory coach application 22, and a sensor 24, the wireless earpiece 10 may further include any number of components. For example, the wireless earpiece 10 may include a bone conduction microphone 30 operatively connected to the processor 14 and positioned to be in contact with the temporal bone of the user when the wireless earpiece is inserted into the user's ear canal. The wireless earpiece 10 may also include a transceiver 32 and/or wireless transceiver 34 operatively connected to the processor 14 and disposed within, mounted to, or integrated with the earpiece housing 12. The wireless earpiece 10 may also include a gesture interface 36 having an emitter 38 and a detector 40 operatively connected to the processor 14 and mounted to or integrated with the earpiece housing 12, one or more integrated LEDs 42, and an energy source 44 operatively connected to each component within the wireless earpiece 10. The sensors 24 may also include a magnetometer 46 and/or an EMG sensor 48 to better read a user's body movements. The sensors 24 may also include a camera and/or Lidar sensor to record body movements and facial expressions to better provide contextual-driven data.

Bone conduction microphone 30 may be operatively connected to the processor 14 and positioned on the earpiece housing 12 to meet a temporal bone of the user when the wireless earpiece 10 is inserted into the user's ear canal. The bone conduction microphone 30 may be configured to communicate sounds and/or vibrations via the temporal bone for users who have difficulty hearing. In addition, the bone conduction microphone 30 may be configured to help filter out sounds to differentiate between sounds originating from the user and sounds originating from a third party or another external location.

The transceiver 32 may be operatively connected to the processor 14 and disposed within, mounted to, or integrated with the earpiece housing 12. Transceiver 32 may be a near field magnetic induction (NFMI) transceiver, a Bluetooth transceiver, a WiMAX transceiver, a Wi-Fi transceiver, or another type or class of transceiver meeting one or more IEEE standards. In addition, more than one type of transceiver, such as a hybrid or multi-mode transceiver, may be in the wireless earpiece 10. Transceiver 32 may be configured to transmit signals to or receive signals from another earpiece if the user is wearing a set of earpieces 50. The transceiver 32 can receive signals from mobile devices, communications towers, Wi-Fi hotspots, satellites, mobile devices, desktops, laptops, watches, or other electronic devices or other communication devices locations. For example, signals received by a user's mobile device 60 (e.g., 3G, 4G, 5G, PCS, LTE, etc.) encoding programs for use by the wireless earpiece 10 may be transmitted by the mobile device 60 to the transceiver 32.

In one embodiment, the transceiver 32 may communicate the signals to the processor 14, which may use the data and/or information encoded in the signals during execution of one or more programs or applications (such as a memory test) and/or store the data and/or information in the memory 20. For example, if a memory test the user desires is not stored on the memory 20, the user may instruct their mobile device 60 having a copy of the memory test to upload the program to the wireless earpiece 10. In another embodiment, the user may instruct the wireless earpiece 10 to download the program from the mobile device 60. The memory test may also be run from the mobile device 60 if the memory of the processor 14 or the memory 20 is insufficient for the task.

Gesture interface 36 may be operatively connected to the processor 14 and may be mounted to or integrated with the earpiece housing 12 and may be configured to allow a user to control one or more programs or functions of the wireless earpiece 10. The gesture interface 36 may include at least one emitter 38 and at least one detector 40 to detect gestures from either the user, a third-party, an instrument, or a combination. The gestures may include hand gestures proximate or touching the wireless earpiece 10. The gesture interface 36 may communicate one or more signals or data representing the gesture to the processor 14. For example, the emitter 38 and the detector 40 may detect contact, infrared emissions, visible light, or other signals. The gestures may be used with the gesture interface 36 to control the wireless earpiece 10 include, without limitation, touching, tapping, swiping, hand motions proximate the emitter 38 and the detector 40, use of an instrument, head motions, or any combination of the gestures. Touching gestures used to control the wireless earpiece 10 may be of any duration and may include the user's body or touching areas of the wireless earpiece 10 not part of the gesture interface 36. Tapping gestures used to control the wireless earpiece 10 may include any number of taps and need not be brief. Swiping gestures used to control the wireless earpiece 10 may include a single swipe, a swipe changing direction at least once, a swipe with a time delay, a plurality of swipes, or any combination. Other gestures may include hand gestures or signals made proximate the wireless earpiece 10. All the gestures described above may also be stored in memory 20 and used by memory application 22 as context-driven data to determine a user's performance during a memory application 22.

Light emitting diodes (LEDs) 42 may be operatively connected to the processor 14 and may be mounted to or integrated with the earpiece housing 12. The LEDs 42 may be semiconductor-based light sources and may include displays, touch sensors, and/or other interactive interface components. In addition, the LEDs 42 may be configured to provide information concerning the wireless earpiece 10. For example, the processor 14 may communicate a signal encoding information related to the current time, the energy level of the wireless earpiece 10, the status of another operation of the wireless earpiece 10, the coaching application (e.g., answer status, performance, etc.), or another earpiece program or function to the LEDs 42.

In one embodiment, if the signal concerns the energy level of the wireless earpiece 10, the LEDs 42 may decode the signal as a colored light. For example, a green light may represent a substantial level of battery life, a yellow light may represent an intermediate level of battery life, a red light may represent a limited amount of battery life, and a blinking red light may represent a critical level of battery life requiring immediate recharging. The information provided by the LEDs 42 may also be accompanied by feedback from a vibrator, electrical contacts, tactile feedback generator, or speaker to further alert the user. In addition, the battery life may be represented by the LEDs 42 as a percentage of battery life remaining or may be represented by an energy bar having one or more LEDs. For example, the number of illuminated LEDs may represent the amount of battery life remaining in the wireless earpiece 10. The LEDs 42 may be in any area on the wireless earpiece 10 suitable for viewing by the user or a third party and may also consist of as few as one diode which may be provided in combination with a light guide. In addition, the LEDs 42 need not have a minimum luminescence.

Energy source 44 is operatively connected to all the components within the wireless earpiece 10. The energy source 44 may provide enough power to operate the wireless earpiece 10 for a reasonable duration of time. The energy source 44 may be of any type suitable for powering the wireless earpiece 10. For example, the energy source 44 may represent a battery, a fuel cell, thermal electric generator, piezo electric charger, solar charger, ultra-capacitor, or other existing or developing power storage technologies. In other embodiments, the energy source 44 need not be present in the wireless earpiece 10. For example, the wireless earpiece 10 may be powered through a wired conductor magnetically interfacing with the wireless earpiece 10. In another embodiment, alternative battery-less power sources, such as sensors configured to receive energy from radio waves (all of which are operatively connected to one or more earpieces) may be used to power the wireless earpiece 10 in lieu of an energy source 44.

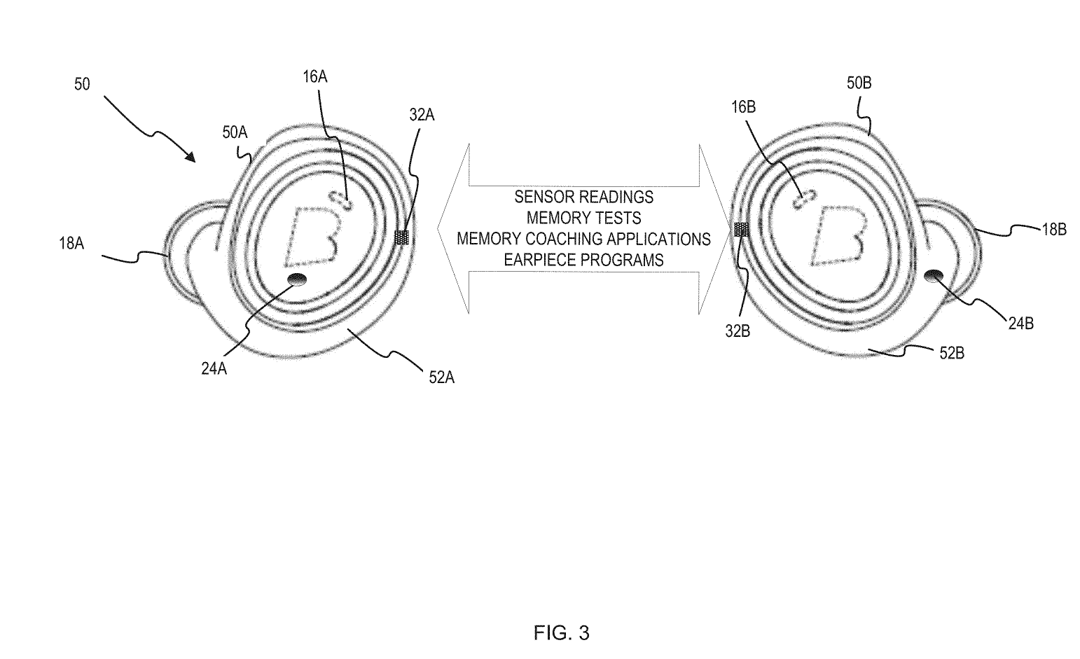

FIG. 3 illustrates a set of earpieces 50 which includes a left wireless earpiece 50A and a right wireless earpiece 50B. The left wireless earpiece 50A has a left earpiece housing 52A. The right wireless earpiece 50B has a right earpiece housing 52B. The left earpiece 50A and the right earpiece 50B may be configured to fit on, at, or within a user's external auditory canal and may be configured to substantially minimize or eliminate external sound capable of reaching the tympanic membranes. The earpiece housings 52A and 52B may be composed of any material with substantial deformation resistance and may also be configured to be soundproof or waterproof.

A microphone 16A is shown on the left wireless earpiece 50A and a microphone 16B is shown on the right wireless earpiece 50B. The microphones 16A and 16B may be located anywhere on the left earpiece 50A and the right earpiece 50B respectively and each microphone may be positioned to receive one or more sounds from the user, one or more sounds from a third party, or one or more ambient sounds from an object worn or carried by the user or the outside environment, whether natural or artificial. The microphones 16A and 16B may represent any number of over-air microphones, ear-bone/bone conduction microphones, or so forth. The left wireless earpiece 50A and the right wireless earpiece 50B may each include several different microphones.

A speaker 18A is shown on the left wireless earpiece 50A and a speaker 18B is shown on the right wireless earpiece 50B. Speakers 18A and 18B may be positioned proximate to the user's tympanic membranes and may also be configured to short out if any sounds exceed a certain decibel threshold, which may be preset or programmed by the user or a third party. The speakers 18A and 18B may be configured to generate any number of frequencies or ranges (e.g., tweeter, mid-range, bass, etc.). The speakers 18A and 18B may also include various speaker components and devices. The speakers 18A and 18B may also perform noise cancellation as requested by the user.

Sensors 24A and 24B are also shown. Sensors 24A and 24B may be configured to sense any body movements or user input performed by the user for use in a memory application and memory coaching processes. Transceivers 32A and 32B are also shown. In one embodiment, the transceivers 32A, 32B may be disposed within the earpiece housings 52A and 52B. The transceivers 32A and 32B may be configured to share sensor readings from the sensors 24A and 24B when the user is performing one or more memory tests or programs to allow the processors of the set of wireless earpieces 50 to better gauge how well the user is performing. In addition, memory tests, programs, and/or memory coaching applications may also be shared between the left wireless earpiece 50A and the right wireless earpiece 50B via transceivers 32A, 32B. The speakers 18A and 18B may also communicate questions, answers, feedback, statistics, progress, updates, or so forth.

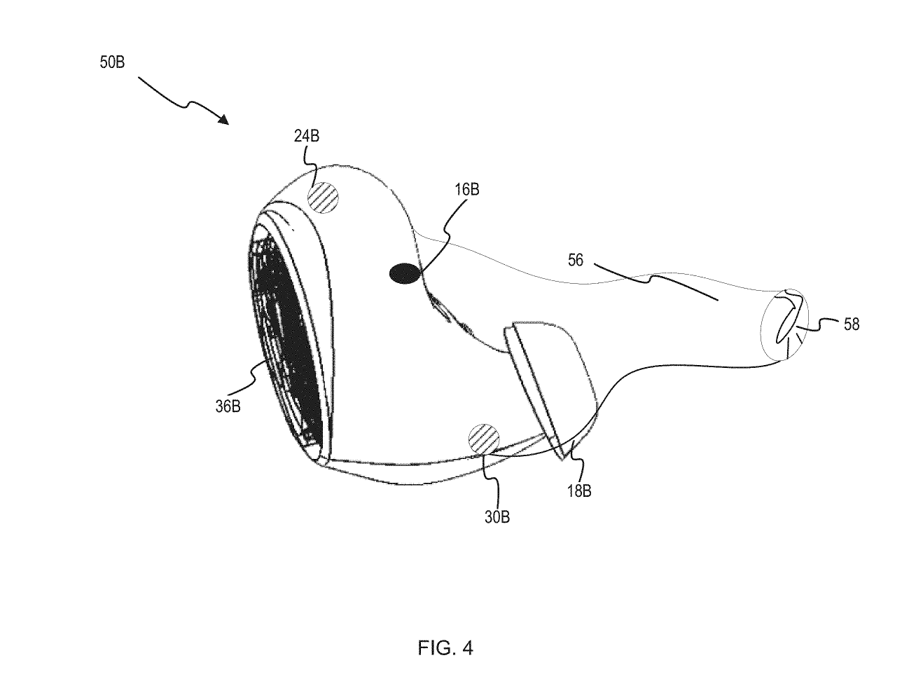

FIG. 4 illustrates a side view of the right wireless earpiece 50B and its relationship to a user's ear. The following description may also apply to wireless earpiece 10 of FIG. 3. The right wireless earpiece 50B may be configured to both minimize the amount of external sound reaching the user's external auditory canal 56 and to facilitate the transmission of communicated sounds from the speaker 18B to a user's tympanic membrane 58. The right wireless earpiece 50B may also be configured to be of any size necessary to comfortably fit within the user's external auditory canal 56 and the distance between the speaker 18B and the user's tympanic membrane 58 may be any distance sufficient to facilitate transmission of the communicated sounds to the user's tympanic membrane 58.

A sensor 24B which may include an MEMS gyroscope, an accelerometer, a magnetometer, global positioning system (GPS), and/or an EMG sensor, may be positioned within the right wireless earpiece 50B to sense one or more of (1) body movements, (2) body position/orientation/location, and/or (3) actions and activities in the head and neck regions. For example, the sensor 24B may be positioned within the right wireless earpiece 50B to capture similar data. The sensor data from the sensors 24A and 24B may include arm movements, hand movements, finger movements, leg movements, foot movements, head movements, neck movements, or other physical movements.

In addition, a bone conduction microphone 30B may be positioned near the temporal bone of the user's skull to receive sound vibrations for people who have difficulty speaking loudly. The bone conduction microphone 30B may also sense sounds before the sounds reach the microphones 16B to differentiate between sounds from the user and ambient sounds. As a result, user input and sounds are recorded more accurately by the right wireless earpiece 50B. The gesture interface 36B may provide for gesture control by the user or a third party such as by tapping or swiping across the gesture interface 36B, tapping or swiping across another portion of the right wireless earpiece 50B, providing a gesture not involving the touching of the gesture interface 36B or another part of the right wireless earpiece 50B, or through the use of an instrument configured to interact with the gesture interface 36B. The user may use the gesture interface 36B to select a memory test or memory coaching application or to control another function of the right wireless earpiece 50B.

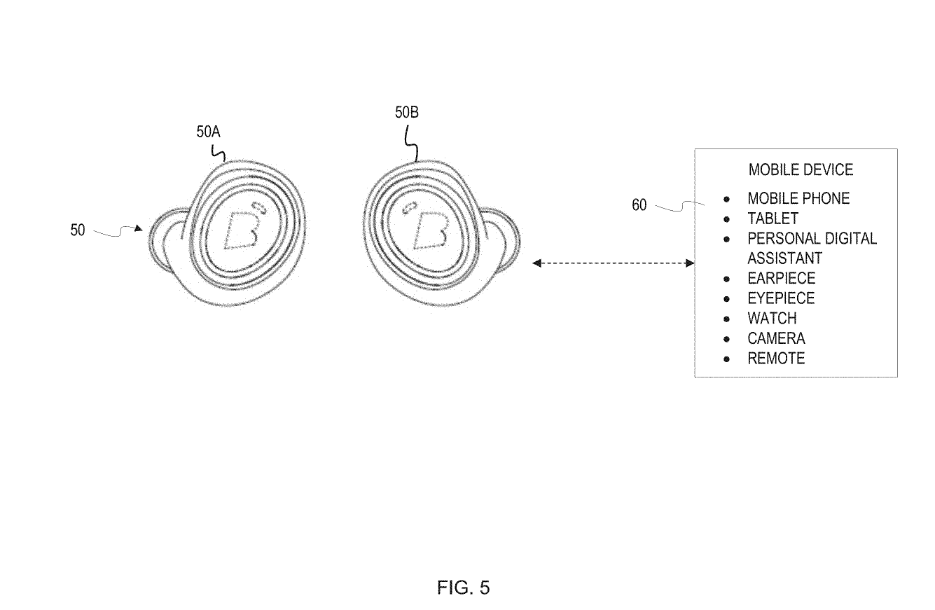

FIG. 5 illustrates a set of wireless earpieces 50 and their relationship to a mobile device 60. The wireless earpieces 50 include a left wireless earpiece 50A and a right wireless earpiece 50B. The mobile device 60 may be a mobile phone, a tablet, a watch, a PDA, a remote, an eyepiece, an earpiece, or any electronic device not requiring a fixed location. The user may use a software application on the mobile device 60 to select a memory test or memory coaching application to use with one or both wireless earpieces 50. The selection may be communicated to the set of earpieces 50 via a transceiver of the mobile device 60. In addition, the user may use the mobile device 60 to download programs, memory tests, and/or memory coaching applications to one of the wireless earpieces 50A, 50B or the set of wireless earpieces 50 where they can be used directly. Other programs may also be downloaded to the set of wireless earpieces 50 using the mobile device 60 as well. The mobile device 60 may also download results related to memory tests or programs performed by the user from the set of wireless earpieces 50 for analysis. For example, a medical professional may wish to see the results of a memory test in making a diagnosis related to dementia or Alzheimer's disease. In another example, the memory coaching application may be utilized to train salesmen, customer service representatives, employees, or so forth.

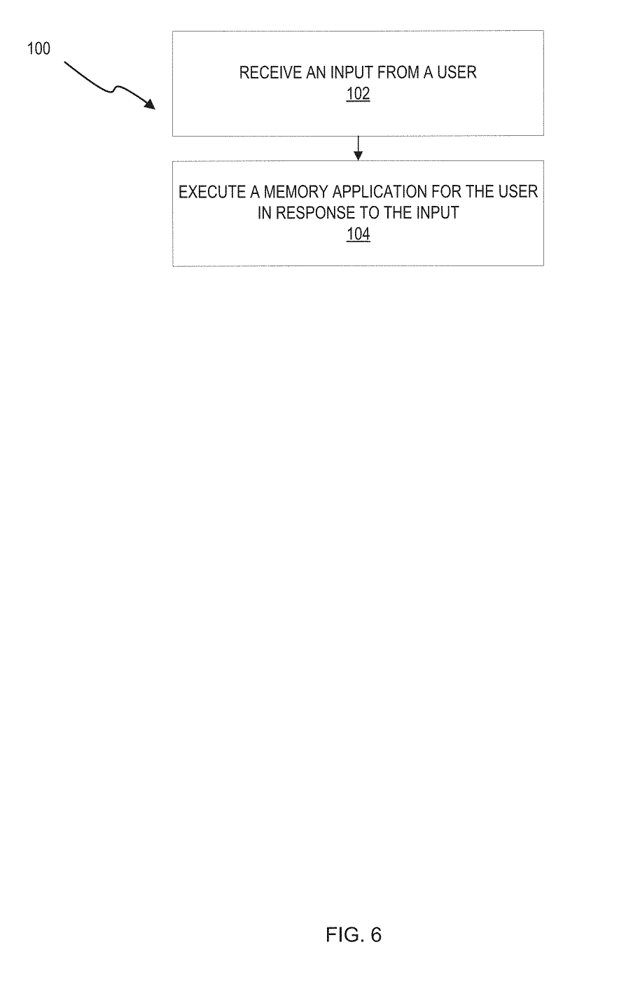

FIG. 6 illustrates a flowchart of a method of utilizing a memory application using an earpiece 100 in accordance with an illustrative embodiment. First, in step 102, the wireless earpiece 10 receives an input from the user. The input may be a voice command requesting a memory test, a voice command requesting a memory coaching application or program, a sensor reading from a sensor (e.g., head, hand, or finger gesture, tactile input, etc.), and/or an ambient sound. If the input is a voice command for a specific memory test or memory coaching application, the specific memory test or memory coaching application may be immediately initiated, executed, or prompted. One or more queries or prompts may be provided to the user before the memory test or application begins. If the input is a sensor reading, the sensor reading may initiate or prompt the user or a third party without a direct input from either the user or a third party. In addition, if the input is an ambient sound, the ambient sound may initiate or prompt the user or a third party without a direct input from either the user or a third party much like if the input is a sensor reading. Sensor readings and ambient sounds may also be stored in the memory 20 for concurrent or later use.

In step 104, a memory application is executed for the user wearing the wireless earpiece in response to the input. The memory application may be a memory test, a memory coaching application, or an application having a memory test or memory coaching application. The memory application may be administered either continuously or intermittently depending on the type of memory application. For example, if the memory application is a short-term memory test, the test may be administered continuously until the user successfully completes the test or ceases the exam. In another embodiment, if the memory application is a long-term memory test, the test may be provided intermittently (e.g., the user is asked to remember a string of numbers and is not prompted for the answer for another thirty minutes). The memory application may cease in accordance with its instructions, in response to one or more applications concurrently running on the wireless earpiece 10, in response to a signal received from an outside electronic device, or due to a command from the user or a third party. During step 104, a memory test may be initiated or administered to the user. As noted the memory application may perform a process or instructions associated with a single test or may be ongoing.

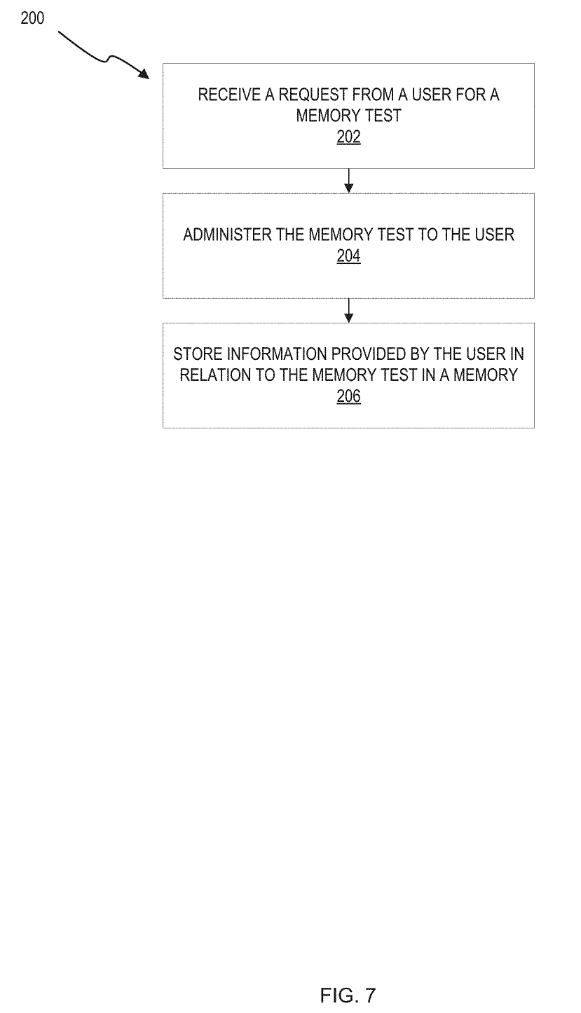

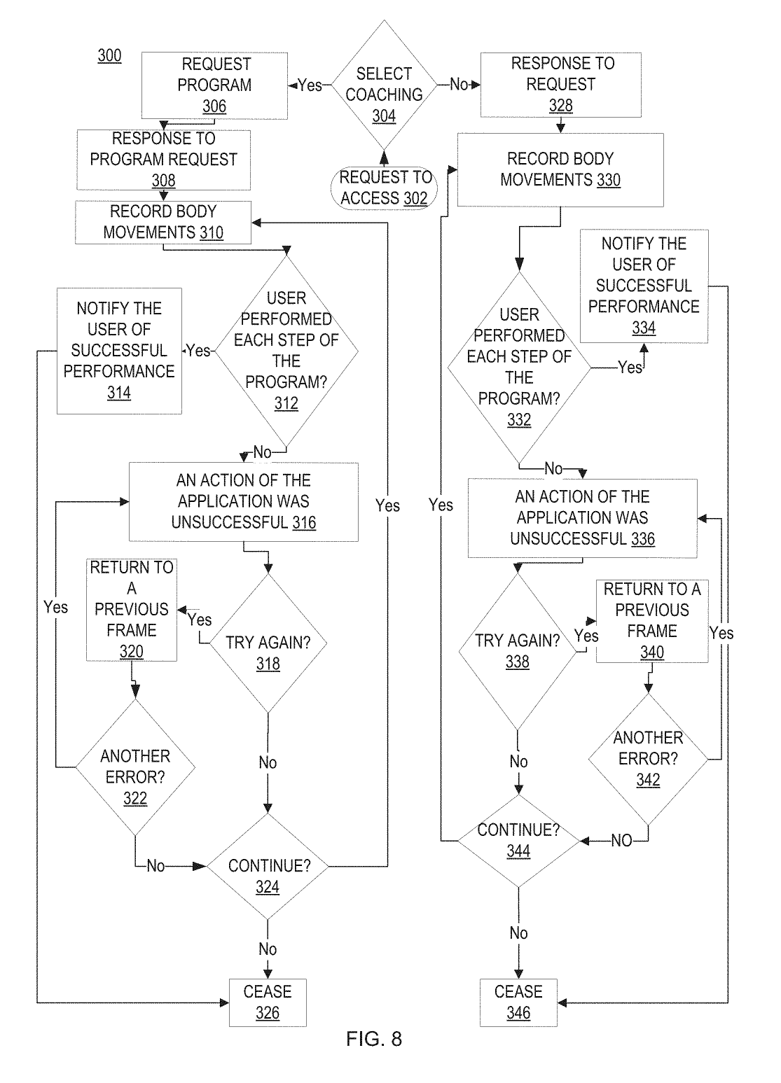

FIG. 7 illustrates a flowchart 200 of a method of providing a memory test to a user wearing an earpiece in accordance with an illustrative embodiment. In one embodiment, the process of FIG. 8 may begin in step 202 with the wireless earpiece receiving a request from the user for a memory test. In another embodiment, the request may be received from an administrator, guardian, teacher, trainer, or other individual, organization, group, team, entity, or so forth. The memory test may be a short-term memory test testing immediate or recent memory, a long-term test testing remote memory, or a combination of both types. For example, the user may select a memory test using a voice command received by the microphone of the wireless earpiece testing (1) immediate memory by providing a list of words and asking the user to repeat the words back to the wireless earpiece 10, (2) recent memory by asking where the user was located over the past week, and/or (3) remote memory by asking the user about certain events (such as the playoff record of a sports team) happening years ago. The recent events and the remote events used by the memory test may be stored in the memory in response to an operation of one or more programs on the wireless earpiece or in response to a program which prompts the user or a third party for the requisite information. The information may be provided directly by the user or a third party or indirectly via the microphone or one or more sensors of the wireless earpiece. The memory test may be initiated by a memory application, logic, third-party applications, or so forth.

In step 204, the memory test is administered to the user. The memory test may be administered immediately after selection by the user or a third party. In one embodiment, the selection may be performed by way of a voice command from the user or a third party, a gesture received by a gesture interface from the user or a third party, user preferences, user actions/activities, and/or in response to one or more ambient sounds. In addition, the memory test may require additional information prior to commencement. For example, the memory test may inquire as to the age of the user, the proper language settings, the type of memory test (e.g. a number test or a word test), or other information necessary to administer the memory test to the user. The user may also set the program to cease after a mistake, to provide hints or clues if the user misses a question or takes too long to answer a question, or to rewind or return to a previous point so the user may try the question again.

In step 206, information provided by the user is stored in the memory. The information may be stored contemporaneously with the operation of the memory test, in accordance with one or more instructions of the memory test or another program running on the wireless earpiece, in response to a command from the user (which may be in response to a prompt from the memory test), or in response to a command from a third party. The information stored during step 206 may be compiled along with additional results to acquire memory information for one or more users utilizing the wireless earpieces.

FIG. 8 illustrates a flowchart of a method of providing a memory coaching application 300 with a wireless earpiece having at least one sensor. The process of FIG. 8 may be performed by wireless earpieces as a set or a single wireless earpiece. First, in step 302, the wireless earpiece receives a request to access an application. The application may be a stand-alone memory coaching application or a program having a memory coaching function. If the user selects a memory coaching application in step 304, then in step 306, the wireless earpiece receives a request for a program to use with the memory coaching application. The memory coaching application may prompt the user to set or calibrate the program parameters, so the memory coaching application may properly coach the user. For example, if the user selects a yoga routine after selecting a memory coaching application, the memory coaching application may prompt the user as to the specific program the memory coaching application is to be used for. In addition, the memory coaching application may also prompt the user as to the user's physical measurements and any types of movements the sensors are to record.

In step 308, the program in which the memory coaching application is to be used commences in response to the program request. For example, the program may commence in response to the user or a third party, internal instructions within the program, internal instructions within the memory coaching application, or after finishing calibration if calibration is required.

In step 310, the sensors record body movements. In one embodiment, the sensor measurements are to be used with the memory coaching application and the program. This can be context-driven data, which may be used to assist with the memory coaching program. The body movements, position, and orientation sensed or recorded by the sensors may include gyroscope and accelerometer measurements which may be compared to model readings of the program, EMG sensor readings of the user's head and/or neck muscles, magnetometer sensor readings, pulse oximeter readings, or other types of sensor readings useful in ascertaining physical movements, position, orientation, and location.

In step 312, a determination is made whether the user successfully performed each step of the program. If the user successfully performs each step of the program in step 312, then in step 314, the memory coaching application notifies the user they successfully performed each action.

If the user does not perform one or more actions in accordance with the program as determined during step 312, then in step 316 the memory coaching application performs an action providing notice to the user at least one step in the program was not completed satisfactorily. The notification may be provided verbally or audibly via the speaker of the wireless earpiece, via three-dimensional sound or audio cues in the correct area of the action through the speaker, through tactile feedback, through visual clues, by ceasing the program, by rewinding the program, or a combination of the actions, and the preceding list is non-exclusive. In addition, the memory coaching application may provide memory-related tips or advice on how to improve adherence to the required actions of the program.

In step 318, the wireless earpieces determine whether the user wants to try again. If the user does want to try again in step 318, in step 320 the program returns to a previous frame. The program frame may be a point prior to the notification provided by the memory coaching application or a point contemporaneous with the notification.

In step 322, the wireless earpieces determine whether the user makes another error. If another mistake is made as determined during step 322, the program and memory coaching application returns to step 316. As previously noted for step 316, the notification regarding mistakes or errors may be provided verbally via the speaker of the wireless earpiece, via three-dimensional sound or audio cues in the correct area of the action through the speaker, by ceasing the program, by rewinding the program, or a combination of the actions, and the preceding list is non-exclusive. During step 316, the memory coaching application may provide additional or supplemental memory-related tips or advice on how to improve adherence to the required actions of the program.

In step 324, the wireless earpieces determine whether the user wishes to continue. If the user wishes to cease the program in step 324, then the program and the memory coaching application cease in step 326. If not, then the program returns to step 310. Information related to the program may be stored in the memory 20 upon cessation of the program and/or memory coaching application.

If the user selects a program with a built-in memory coaching function during step 304, then in step 328 the program commences in response to the application request. The program may commence in response to the user, in response to one or more third parties, to internal instructions within the program, or after finishing calibration if calibration is required. In step 330, the sensors record body movements to be used with the program. The body movements sensed or recorded by the sensors may include gyroscope and accelerometer measurements which may be compared to model readings of the application, EMG sensor readings of the user's head and/or neck motions or actions, magnetometer sensor readings, pulse oximeter readings, or any other type of sensor readings useful in ascertaining physical movements, orientation, position, and location.

In step 332, the wireless earpieces determine where the user successfully performs each step of the application. If the steps were performed successfully as determined during step 332, in step 334 the application notifies the user they successfully performed each action. If the user does not perform one or more actions in accordance with the application during 332, then in step 336 the program performs an action providing notice to the user at least one step in the application was not completed satisfactorily. The notification may be provided verbally via the speaker of the wireless earpiece, via three-dimensional sound or audio cues in the correct area of the action through the speaker, by ceasing the program, by rewinding the program, or a combination of the actions, and the preceding list is non-exclusive. In addition, the memory coaching application may provide memory-related tips or advice on how to improve adherence to the program's required actions.

In step 338, the wireless earpieces determine whether the user wishes to try again. If the user does want to try again as determined during step 338, in step 340 the program returns to a previous frame. The program frame may be a point prior to the notification provided by the program or a point contemporaneous with the notification. Thus, the user may attempt the training or process of the memory coaching application.

If the user makes another error as determined during step 342, then the program returns to step 336. As previously described in step 336, the notification may be provided verbally via the speaker of the wireless earpiece, via three-dimensional sound or audio cues in the correct area of the action through the speaker, by ceasing the program, by rewinding the program, or a combination of the actions, and the preceding list is non-exclusive. Also, like step 336, the memory coaching application may provide memory-related tips or advice on how to improve adherence to the program's required actions. If the user wishes to cease the program in step 344, then the program and the memory coaching application cease in step 346. If not, then the program returns to step 330. Information related to the program may be stored in the memory upon cessation of the program.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

The previous detailed description is of a small number of embodiments for implementing the invention and is not intended to be limiting in scope. The following claims set forth several embodiments of the invention disclosed with greater particularity.

What is claimed is:

1. A wireless earpiece comprising:
an earpiece housing;
a processor disposed within the earpiece housing;
a microphone operatively connected to the processor;
a speaker operatively connected to the processor;
one or more sensors operatively connected to the processor;
a memory operatively connected to the processor; and
a memory application stored in the memory and executable by the processor, wherein the memory application is configured to generate a memory application test for the user to test a memory of the user wearing the wireless earpiece;
wherein the memory application test comprises a plurality of audio questions transduced at the speaker with responses to the plurality of audio questions received by at least one of the microphone and the one or more sensors;
wherein the memory application test provides for evaluating the responses to the plurality of audio questions to generate a memory application test score.

2. The wireless earpiece of claim 1 wherein the memory application uses context-driven data, provided by the one or more sensors in evaluating the responses.

3. The wireless earpiece of claim 1, wherein the memory application is a memory coaching application.

4. The wireless earpiece of claim 1, wherein the memory application is a program comprising a memory coaching application.

5. The wireless earpiece of claim 1, wherein the one or more sensors comprisess a gyroscope and an electronic accelerometer for sensing non-verbal input from the user relating to the memory application test.

6. A method of providing a memory application using an earpiece comprising:
receiving an input from a user at the wireless earpiece;
executing a memory application by a processor of the earpiece for the user in response to the input;
prompting the user to remember information, the prompting performed by the earpiece;
requesting the information from the user, the requesting performed by the earpiece; and
receiving user input at the earpiece in response to requesting the information from the user.

7. The method of claim 6, wherein the wireless earpiece is worn in an ear of the user.

8. The method of claim 6, wherein the input is a voice command or sensor input

9. The method of claim 6, wherein the memory application performs a memory test for the user to determine a baseline level associated with the user.

10. The method of claim 6, wherein the memory application is a memory test or a memory coaching application.

11. The method of claim 6, further comprising communicating audio feedback to the user if the user does not correctly adhere to the memory application.

12. A method for testing a memory of a user utilizing wireless earpieces, comprising:
testing the memory of the user by the wireless earpieces to determine a baseline level;
performing memory exercises based on the baseline level determined for the user;
receiving at the wireless earpieces user input based on the memory exercises; and
scoring the user based on the memory exercises, the scoring performed by the wireless earpieces.

13. The method of claim 12, wherein the scoring further comprises:
determining mental health of the user based on the score and the memory exercises and testing.

14. The method of claim 12, wherein the memory exercises are performed over time improving or treating the memory of the user.

15. The method of claim 12, further comprising:
communicating the scoring and results of the memory exercises to one or more designated parties.

16. The method of claim 12, wherein the memory exercises provides a diagnosis to the user relating to mental health of the user.

17. The method of claim 12, wherein the memory application accepts context-driven data to determine the user's performance on the memory exercises.

18. The method of claim 12, wherein the memory exercises train the user to remember information associated with a job of the user.
